(19) United States
(12) Patent Application Publication
(10) Pub. No.: US 2023/0040783 A1
(43) Pub. Date: Feb. 9, 2023

(54) APPARATUS AND METHOD FOR CONTROLLING AUTONOMOUS VEHICLE

(71) Applicants: HYUNDAI MOTOR COMPANY, Seoul (KR); KIA CORPORATION, Seoul (KR)

(72) Inventors: Jun Hyuk Choi, Hwaseong-si (KR); Sung Woo Hong, Gwacheon-si (KR); Nam Young Oh, Seoul (KR); Tae Sung Kim, Seoul (KR); Hwan Soo Moon, Busan (KR)

(73) Assignees: Hyundai Motor Company, Seoul (KR); KIA CORPORATION, Seoul (KR)

(21) Appl. No.: 17/856,361

(22) Filed: Jul. 1, 2022

(30) Foreign Application Priority Data
Aug. 9, 2021 (KR) 10-2021-0104832

(51) Int. Cl. B60W 60/00; B60W 30/09; B60W 30/14; B60W 40/02; B60W 50/14; G06V 20/58; G06V 20/62

(52) U.S. Cl. CPC B60W 60/0011; B60W 60/0015; B60W 60/005; B60W 30/09; B60W 30/143; B60W 40/02; B60W 50/14; G06V 20/58; G06V 20/625; B60W 2050/146; B60W 2420/42; B60W 2420/52; B60W 2420/54; B60W 2554/4041

(57) ABSTRACT

The present disclosure relates to an apparatus and method for controlling an autonomous vehicle to allow an autonomous vehicle to safely pass through a road according to a driver's choice when the width of the road is narrow. The apparatus includes a sensor for acquiring information data of obstacles and vehicles in front of and on a side of a host vehicle, a signal processor for outputting data with respect to positions and media of obstacles and a determination signal representing presence or absence of a vehicle on a driving path, a controller for determining whether driving is possible by analyzing information acquired by the sensor and outputting a control signal corresponding to a selection signal of the driver, an interface for displaying an image processed by the signal processor, and an autonomous driving function unit for performing autonomous driving according to the control signal.

### CROSS REFERENCE TO RELATED APPLICATION

This application claims the benefit of Korean Patent Application No. 10-2021-0104832, filed on Aug. 9, 2021, which is hereby incorporated by reference as if fully set forth herein.

### TECHNICAL FIELD

The present disclosure relates to an apparatus and method for controlling an autonomous vehicle, and more specifically, to an apparatus and method for controlling an autonomous vehicle to allow an autonomous vehicle to be able to safely pass through a road according to a driver's choice when the width (breadth) of the road is determined to be narrow from the calculation.

### BACKGROUND

On a road where various obstacles exist, such as a narrow road or an alley, a driver determines whether to pass by relying on his or her senses. Although a vehicle enters as it is determined that the vehicle can pass by the driver's determination, when it is impossible to actually pass, there is a problem that it may cause traffic congestion and provide inconvenience to the driver.

In order to solve this problem, a technology for automatically determining whether a vehicle can pass or not using various sensors on a narrow road and providing such information to a driver has been developed.

However, even in the case of a drivable narrow road, there is still an inconvenience in that a novice driver who is inexperienced in driving has difficulty passing through the narrow road.

### SUMMARY

Accordingly, the present disclosure is directed to an apparatus and method for controlling an autonomous vehicle that substantially obviate one or more problems due to limitations and disadvantages of the related art.

An object of the present disclosure is to provide an apparatus and method for controlling an autonomous vehicle which can prevent the occurrence of a contact accident by controlling an autonomous vehicle to perform an autonomous driving function on a drivable narrow road.

Another object of the present disclosure is to provide an apparatus and method for controlling an autonomous vehicle which can improve reliability by reconfirming whether driving is possible by reflecting a driver's intention in the determination of a degree of risk of various sensors.

To achieve these objects and other advantages and in accordance with the purpose of the disclosure, as embodied and broadly described herein, an apparatus for controlling an autonomous vehicle may include a sensor configured to acquire information data of obstacles and vehicles in front of and on a side of a host vehicle, a signal processor configured to output data with respect to positions and media of the obstacles and a determination signal representing presence or absence of a vehicle on a driving path using the information data acquired by the sensor unit, a controller configured to determine whether driving is possible by analyzing the information data acquired by the sensor unit, to interface with a driver, and to output a control signal corresponding to a selection signal of the driver, an interface configured to display an image processed by the signal processor and to interface with the controller, and an autonomous driving function unit configured to perform autonomous driving according to the control signal provided from the controller.

In the apparatus for controlling an autonomous vehicle according to the present disclosure, the sensor may include a non-image sensor including a light detection and ranging (lidar) sensor, a radio detection and ranging (radar) sensor, an infrared sensor, and an ultrasonic sensor and configured to perform a sensing operation for extracting information on positions and media of obstacles present in front of and on the side of the host vehicle, and an image sensor including a plurality of cameras and configured to extract information on a front view image and a rear view image of the host vehicle.

In the apparatus for controlling an autonomous vehicle according to the present disclosure, the signal processor may determine that an object in front of the host vehicle is a vehicle using a license plate of the vehicle.

In the apparatus for controlling an autonomous vehicle according to the present disclosure, the controller may include a storage unit storing a program for determining narrow roads on the basis of data acquired by the sensor, information on specifications of the host vehicle, and programs necessary for the operation of the autonomous driving function unit.

In the apparatus for controlling an autonomous vehicle according to the present disclosure, the controller may receive, from a driver, a signal for selecting autonomous driving or driving by the driver through the interface upon determining that driving is possible from a result of analysis based on data acquired by the sensor and the information on the specifications of the host vehicle.

In the apparatus for controlling an autonomous vehicle according to the present disclosure, the controller may receive a selection signal for an ignorable obstacle from a driver through the interface and re-determine whether driving is possible by reflecting the selection signal in the re-determination upon determining that driving is impossible from a result of analysis based on the information data acquired by the sensor unit and the information on the specifications of the host vehicle.

In the apparatus for controlling an autonomous vehicle according to the present disclosure, the controller may differentiate a condition that a vehicle is present in an opposite lane, a condition that no vehicle is present in the opposite lane, and a condition that a right turn signal is enabled from one another, derive virtual lines, and determine whether driving is possible.

In the apparatus for controlling an autonomous vehicle according to the present disclosure, the controller may output a control signal for enabling the autonomous driving function unit only when a signal for selecting autonomous driving is received from a driver on condition that driving is possible.

In the apparatus for controlling an autonomous vehicle according to the present disclosure, the controller may terminate the control signal for enabling the autonomous driving function unit when a vehicle in an opposite lane is captured by a rear camera on condition that a vehicle is present in the opposite lane.

In the apparatus for controlling an autonomous vehicle according to the present disclosure, the controller may control the host vehicle to stop when a current driving direction has changed from an initial driving direction by 30° or more on condition that a right turn signal is enabled.

In the apparatus for controlling an autonomous vehicle according to the present disclosure, it is desirable that the autonomous driving function unit maintain a speed of the host vehicle at 20 km/h or lower.

In another aspect of the present disclosure, a method for controlling an autonomous vehicle may include acquiring, by a sensor unit provided in a host vehicle, information data of obstacles and vehicles in front of and on the side of the host vehicle, matching, by a signal processor provided in the host vehicle, information on the obstacles with an image acquired from a camera, determining, by a controller provided in the host vehicle, whether driving is possible on the basis of image information and information on specifications of the host vehicle, performing, by the controller, an operation of interfacing with a driver according to whether driving is possible, and outputting, by the controller, a control signal for executing a function of an autonomous driving function unit when an autonomous driving selection signal is received from the driver.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram schematically illustrating a configuration of an apparatus for controlling an autonomous vehicle according to the present disclosure;

FIG. 2 is a flowchart illustrating a process of a method for controlling an autonomous vehicle according to the present disclosure;

FIG. 3 is a flowchart illustrating a process of controlling an autonomous vehicle when a vehicle is present in an opposite lane in the method for controlling an autonomous vehicle according to the present disclosure;

FIG. 4 to FIG. 6 are exemplary views showing examples of various cases in which a vehicle is present in an opposite lane;

FIG. 7 is a flowchart illustrating a process of controlling an autonomous vehicle in the case where a vehicle is not present in an opposite lane in the method for controlling an autonomous vehicle according to the present disclosure;

FIG. 8 and FIG. 9 are exemplary views illustrating an embodiment of driving on a narrow road when no vehicle is present in an opposite lane;

FIG. 10 is a flowchart illustrating a process of controlling an autonomous vehicle when a right turn signal is operated during driving on a narrow road in the method for controlling an autonomous vehicle according to the present disclosure; and

FIG. 11 is an exemplary view illustrating an embodiment of narrow road driving according to the case of FIG. 10.

### DETAILED DESCRIPTION

With respect to the embodiments of the present disclosure disclosed in the description, specific structural or functional descriptions are only exemplified for the purpose of describing the embodiments of the present disclosure, and the embodiments of the present disclosure may be implemented in various forms and should not be construed as being limited to the embodiments described in the description.

The present disclosure is intended to illustrate specific embodiments in the drawings and describe in detail in the description since the present disclosure can be modified in various manners and can have various forms. However, this is not intended to limit the present disclosure to the specific disclosed form, and it should be understood to include all modifications, equivalents and substitutes included in the spirit and scope of the present disclosure.

Terms such as “first” and “second” may be used to describe various elements, but the elements are not limited by the terms. The above terms are used only for the purpose of distinguishing one component from another. For example, a first component may be referred to as a second component, and similarly, a second component may also be referred to as a first component without departing from the scope of the present disclosure.

When a component is referred to as being “connected” or “coupled” to another component, it may be directly connected or coupled to the other component, but other components may exist in between. On the other hand, when it is said that a certain component is “directly connected” or “directly coupled” to another component, it should be understood that there is no other element in between. Other expressions describing the relationship between elements, such as “between” and “immediately between” or “adjacent to” and “directly adjacent to” should be interpreted similarly.

The terms used in the present application are only used to describe specific embodiments, and are not intended to limit the present disclosure. The singular expression includes the plural expression unless the context clearly dictates otherwise. In the present application, terms such as “comprise” or “have” are intended to designate that the disclosed feature, number, step, operation, component, part, or a combination thereof exists, but it should be understood that the possibility of the presence or addition of one or more steps, operations, components, parts or combinations thereof is not precluded.

Unless defined otherwise, all terms used herein, including technical or scientific terms, have the same meaning as commonly understood by those who skilled in the art to which this disclosure pertains. Terms such as those defined in commonly used dictionaries should be interpreted as indicating meanings consistent with the meanings in the context of the related art, and should not be interpreted in an ideal or excessively formal meaning unless explicitly defined in the present application.

Meanwhile, when an embodiment can be implemented differently, functions or operations specified in a specific block may occur differently from the order specified in the flowchart. For example, two consecutive blocks may be performed substantially simultaneously, or the blocks may be performed in reverse according to a related function or operation.

Hereinafter, an apparatus for controlling an autonomous vehicle and a method for controlling autonomous vehicles using the same according to the present disclosure will be described with reference to the accompanying drawings.

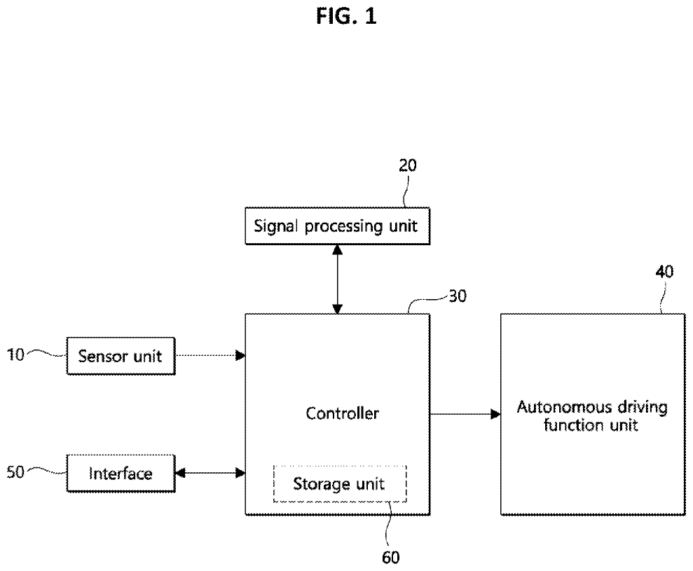

FIG. 1 is a block diagram schematically illustrating a configuration of an apparatus for controlling an autonomous vehicle according to the present disclosure. As illustrated, the apparatus for controlling an autonomous vehicle according to the present disclosure includes a sensor unit (e.g., a sensor) 10, a signal processing unit (e.g., a signal processor) 20, a controller 30, an autonomous driving function unit 40, and an interface 50. In this case, a storage unit (e.g., a storage) 60 may be built in or provided separately in the controller 30 as in this example. The storage unit 60 may include storage media such as a random access memory (RAM), a static random access memory (SRAM), a read-only memory (ROM), a programmable read-only memory (PROM), and an electrically erasable programmable read-only memory (EEPROM). Such an apparatus may be provided to a host vehicle.

The sensor unit 10 executes a function of acquiring information data of obstacles and vehicles in front and on the side of a host vehicle. The sensor unit 10 may include a non-image sensor unit that extracts information on the position and medium of each obstacle located in front and on the side of the host vehicle, and an image sensor unit that extracts image information on a front view image and a rear view image of the host vehicle. In this case, the non-image sensor unit may include at least one of a light detection and ranging (lidar) sensor, a radio detection and ranging (radar), an infrared sensor, and an ultrasonic sensor, and the image sensor unit may include a plurality of cameras.

In an embodiment of the present disclosure, the non-image sensor unit includes a LiDAR sensor and an ultrasonic sensor, for example. Since various non-image sensors can be applied to a vehicle, the apparatus for controlling an autonomous vehicle according to the present disclosure is not limited to a lidar sensor and an ultrasonic sensor, and various sensors corresponding thereto can be used. In addition, a plurality of cameras as the image sensor unit may be provided in a distributed manner to acquire image data with respect to the front, side, and rear of the host vehicle.

Sensing information may include information on a distance from an obstacle, information on a vehicle in an opposite lane, and driving speed information. The information on a vehicle in an opposite lane may include the width and the length of the vehicle in the opposite lane. Sensed information may include road image information, obstacle image information, and lane information. In this case, obstacle image information may include information on the size of an obstacle. If the host vehicle is equipped with a navigation device, obstacle information and road information may be provided from the navigation device. That is, obstacle information and road information may be acquired on the basis of road map information obtainable from the navigation device.

In the following description, sensing information may mean acquired information itself or may mean processed information. For example, when referred to as “road information”, it may mean image information itself obtained by a camera constituting the sensor unit 10 or image information obtained by processing lane information extracted from a road image by the signal processing unit 20 and provided to a driver.

The signal processing unit 20 uses data obtained by the non-image sensor unit of the sensor unit 10 to determine the position and medium of an obstacle. As described above, when a lidar sensor and an ultrasonic sensor are provided as the non-image sensor unit, the lidar sensor detects an obstacle in front of the vehicle that is traveling and the ultrasonic sensor detects an obstacle located on the side of the vehicle. The lidar sensor has a very high recognition rate in both the longitudinal and lateral directions and thus has very small error with respect to adjacent obstacles. Accordingly, the lidar sensor can accurately recognize a road situation. The ultrasonic sensor can recognize a situation on the side of the vehicle to check a current position of the vehicle in a passage. The lidar sensor emits a laser beam to the front of the vehicle that is traveling and calculates a distance to a front obstacle using a time for which the laser beam is reflected from the obstacle and returned.

When the obstacle in front of the vehicle is a conductor, 100% reflection occurs. In the case of an insulator, reflected waves for lidar or ultrasonic waves vary according to the dielectric constant. The dielectric constant has different values depending on the type of a target material. For example, air has a dielectric constant of 1.0, water has a dielectric constant of 80.4, glass has a dielectric constant of 5, PVC has a dielectric constant of 3.4, rubber has a dielectric constant of 6.7, and cement has a dielectric constant of 2.2. The signal processing unit 20 may analyze a signal provided from the lidar sensor on the basis of such dielectric constant to obtain information on the position, size and medium of a front obstacle or a side obstacle.

In addition, the signal processing unit 20 determines presence or absence of a vehicle in the opposite lane. The license plate of the vehicle included in an image provided from a camera of the sensor unit 10 is recognized to check presence or absence of the vehicle. The signal processing unit 20 provides information on the position and medium of an obstacle and information on presence or absence of the vehicle in the opposite lane to the controller 30.

The controller 30 displays a virtual line on a driving route using the obstacle position information and displays the same on a display device such as an AVN (Audio, Video, Navigation) system such that the driver can check the virtual line by matching it with a screen provided from a front camera. In some cases, the virtual line may be displayed through a head-up display device on the windshield in front of the driver.

The controller 30 checks whether the vehicle enters a passage using sensing information received from the sensor unit 10, detects an obstacle located in the passage, calculates the width (breadth) of the passage based on the obstacle, and checks whether the passage is narrow. The controller 30 analyzes information obtained by the signal processing unit 20 to determine whether driving is possible. The controller 30 compares the width (breadth) of at least one road included in the image with the width (breadth) of the host vehicle. If the width (breadth) of the host vehicle is narrower than the width (breadth) of the road, it is determined that driving is possible. If the width (breadth) of the road is narrower than the width (breadth) of the host vehicle, it is determined that driving is impossible.

The controller 30 interfaces with the driver through the interface 50. For example, when it is determined that driving is possible, the controller 30 receives a signal for selecting between autonomous driving and driving by a driver from the driver. When the driver selects autonomous driving, the controller 30 controls the operation of the autonomous driving function unit 40 to perform autonomous driving. When it is determined that driving is impossible, the controller 30 may receive a selection signal for a negligible obstacle through a screen. When the controller 30 receives a negligible obstacle selection signal from the driver, the controller 30 removes the obstacle and then re-determines whether driving is possible.

The interface 50 displays an image processed by the signal processing unit 20 through a display device such as an AVN (Audio, Video, Navigation) system and interfaces with the controller 30. The interface 50 may inform the driver of the existence of a narrow path as a sound in conjunction with the AVN system or may notify the driver of the existence of the narrow path through a screen. The interface 50 may be provided in various forms for implementing an operation of interfacing with the driver, such as a device capable of recognizing the driver's voice or a button disposed on a predetermined portion of the steering wheel to receive a selection signal from the driver.

The storage unit 60 stores image data of passages obtained from a camera sensor under the control of the controller 30, a program for determining a passage as a narrow passage, and various programs for controlling the driving control apparatus.

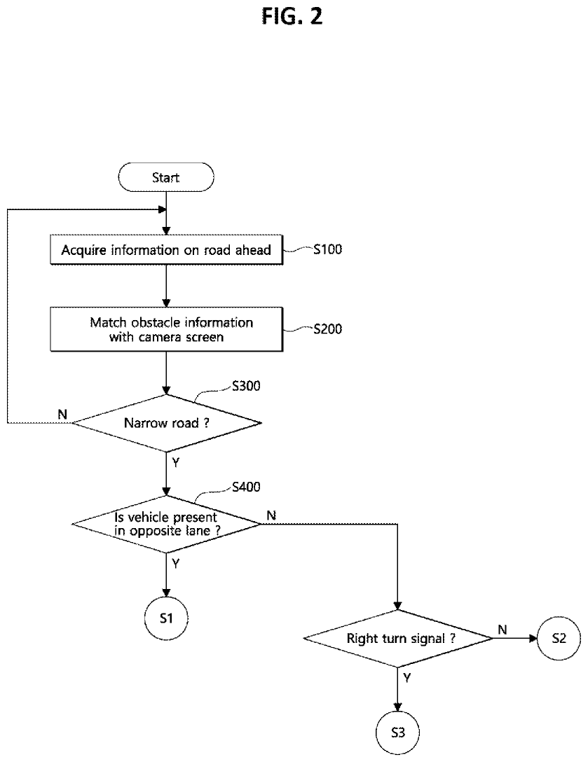

FIG. 2 is a flowchart illustrating a process of a method for controlling an autonomous vehicle according to the present disclosure. Since the subject of the following operation is the controller 30, the subject will be omitted. Information on a road in front of the vehicle is obtained from data extracted by the sensor unit 10 including a lidar sensor, an ultrasonic sensor, and a plurality of cameras (S100).

Information on positions and media of obstacles provided from the signal processing unit 20 and information provided from the cameras are matched with a screen of the road on which the vehicle is traveling (S200).

The width (breadth) of the road on which the vehicle is traveling in consideration of the positions and sizes of the obstacles is compared with the width (breadth) of the vehicle to determine whether the road is a normal road or a narrow road. If a difference between the width (breadth) of the road in consideration of obstacles or parked vehicles and the width (breadth) of the vehicle (e.g., the width (breadth) of the road minus the width (breadth) of the vehicle) is greater than a threshold value, it is determined that the road is not narrow. If the difference (e.g., the width (breadth) of the road minus the width (breadth) of the vehicle) is less than the threshold value, it is determined that the road is narrow (S300).

When it is determined that the road is narrow, it is then determined whether a vehicle is present in the opposite lane (S400), and when the vehicle is present in the opposite lane, step S1 is performed.

If there is no vehicle in the opposite lane in the state in which the road is determined as a narrow road, it is then determined whether a signal for a right turn is operated, and step S2 or S3 is performed depending on whether the signal for a right turn is operated.

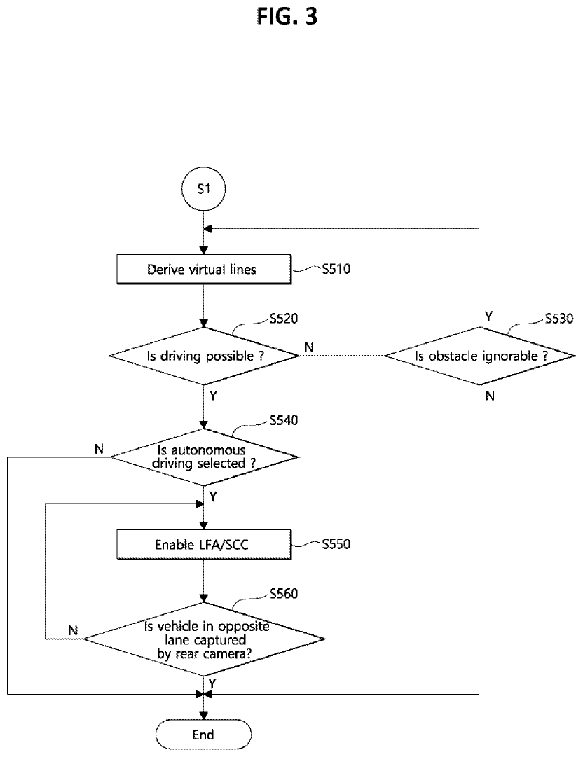

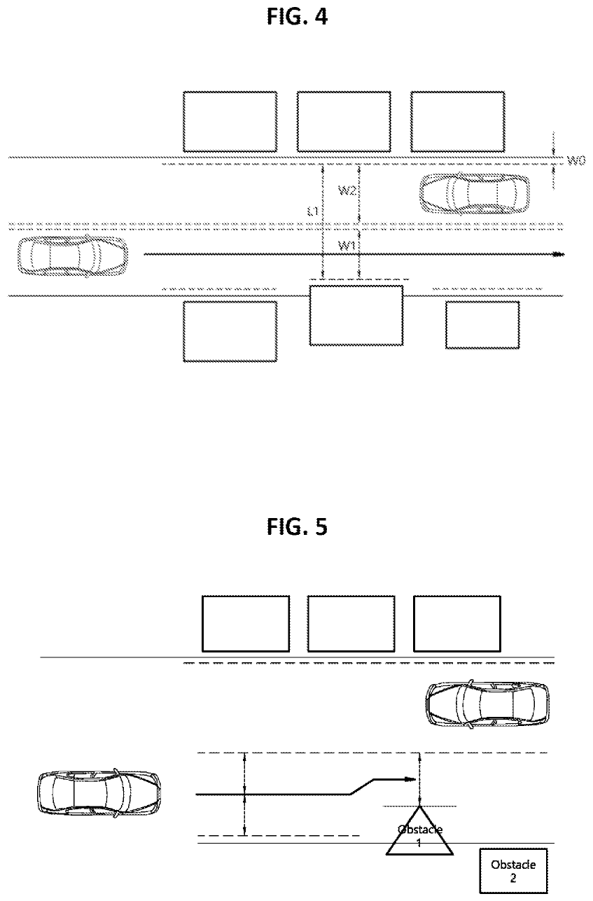

FIG. 3 is a flowchart illustrating a process of controlling an autonomous vehicle when a vehicle is present in an opposite lane in the method for controlling an autonomous vehicle according to the present disclosure, and FIG. 4 to FIG. 6 are exemplary views showing examples of various cases in which a vehicle is present in an opposite lane.

Virtual lines are added to a road image including obstacles. Left and right virtual lines are derived along left and right obstacles, and a virtual center line that becomes the center of the virtual lines is displayed. If a vehicle is present in the opposite lane and an obstacle is present on the driving path of the host vehicle, as shown in FIG. 4, it is determined whether driving is possible using the narrowest width (breadth) L1 of the road on which the host vehicle is traveling, the width (breadth) W1 of the host vehicle, and the width W2 of the opposite lane. In this case, WO is a margin value for safe driving (S510).

When the narrowest width (breadth) L1 of the road on which the host vehicle is traveling is greater than the sum of the width (breadth) W1 of the host vehicle and the width W2 of the opposite lane, it may be determined that driving is possible (S520).

Meanwhile, when it is determined that driving is impossible due to an obstacle, as shown in FIG. 5, the controller 30 inquires of the driver whether the obstacle can be ignored through the interface. The method of notifying the driver may use a screen or voice. If the driver selects an obstacle that can be ignored through the interface, the obstacle is removed and then it is determined whether driving is possible again (S530).

When it is determined that driving is possible, the controller 30 inquires of the driver whether to perform autonomous driving or driving by the driver through the interface. The driver may view the screen on which the virtual lines are displayed through the AVN system, determine the possibility of driving by the driver, and select driving by the driver or autonomous driving (S540).

If the driver selects autonomous driving, the function of the autonomous driving function unit 40 is executed. When autonomous driving is executed, the host vehicle travels closely to the right virtual line according to functions of lane keeping assistance (LFA) and smart cruise control (SCC) (S550).

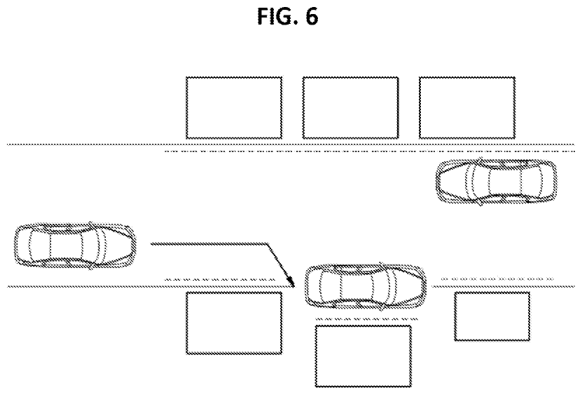

When the host vehicle reaches a widest point of the road at which the host vehicle can pass the vehicle in the opposite lane while scanning obstacles during autonomous traveling closely to the right side, as shown in FIG. 6, the host vehicle stops at the point, or autonomous driving is stopped when the vehicle in the opposite lane is captured by the rear camera (S560).

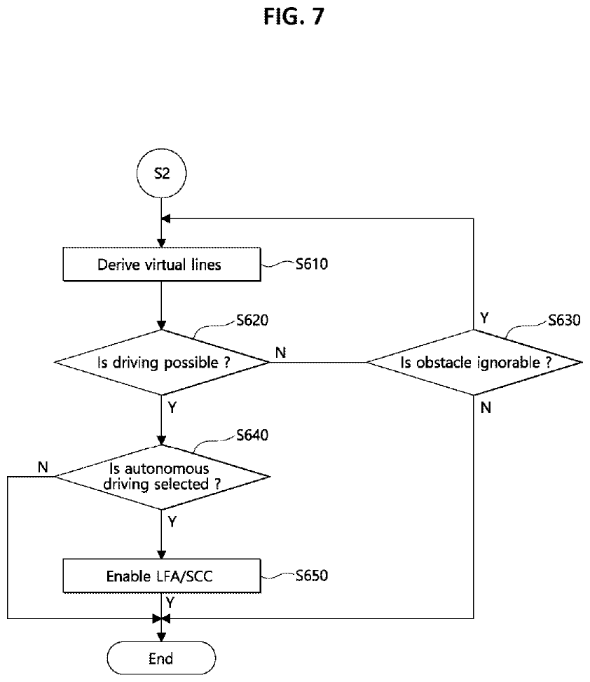

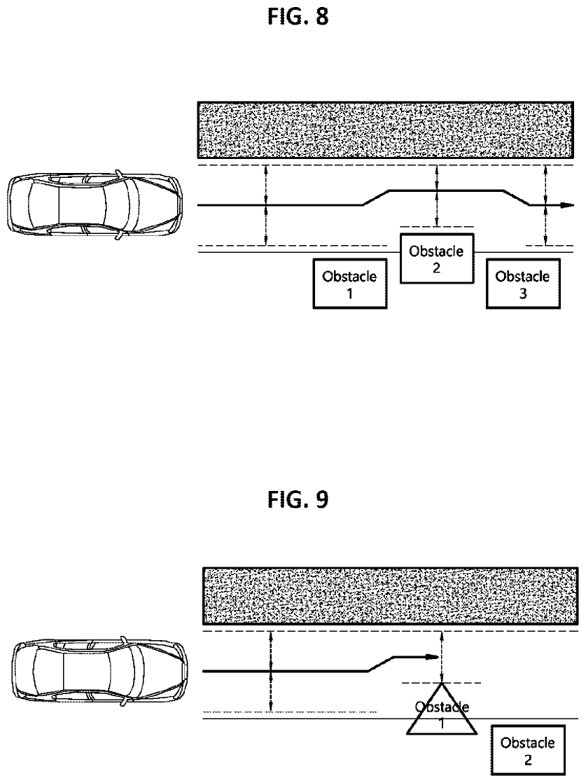

FIG. 7 is a flowchart illustrating a process of controlling an autonomous vehicle in the case where a vehicle is not present in an opposite lane in the method for controlling an autonomous vehicle according to the present disclosure, and FIG. 8 and FIG. 9 are exemplary views illustrating an embodiment of driving on a narrow road when no vehicle is present in an opposite lane.

Virtual lines are added to a road image including obstacles. Virtual lines on the left and right sides of a wide section and a narrow section of a road are derived, and a virtual center line that becomes the center of the virtual lines is displayed. When the width of the road is narrowed due to the obstacle 2, as shown in FIG. 8, it is determined whether driving is possible by comparing the width of the narrow section of the road with the width of the host vehicle. Even in this case, a minimum safety margin value that causes the host vehicle not to come into contact with a curb on the left side and the obstacle on the right side is considered (S610).

If the width of the narrow section of the road is greater than the width of the host vehicle, it may be determined that driving is possible (S620). In this case, if it is determined that driving is impossible due to an obstacle, as shown in FIG. 9, the controller inquires of the driver whether the obstacle can be ignored through the interface. The method of notifying the driver may use a screen or voice. If the driver selects an obstacle that can be ignored through the interface, the obstacle is removed and then it is determined whether driving is possible again (S630).

When it is determined that driving is possible, the controller 30 inquires of the driver whether to perform autonomous driving or driving by the driver through the interface. The driver may view the screen on which the virtual lines are displayed through the AVN system, determine the possibility of driving by the driver, and select driving by the driver or autonomous driving (S640).

If the driver selects autonomous driving, the function of the autonomous driving function unit 40 is executed. When autonomous driving is executed, the host vehicle travels along the virtual center line according to the functions of LFA and SCC. When the host vehicle passes through a narrow section of the road and reaches a wide section of the road, new virtual lines are created (S650).

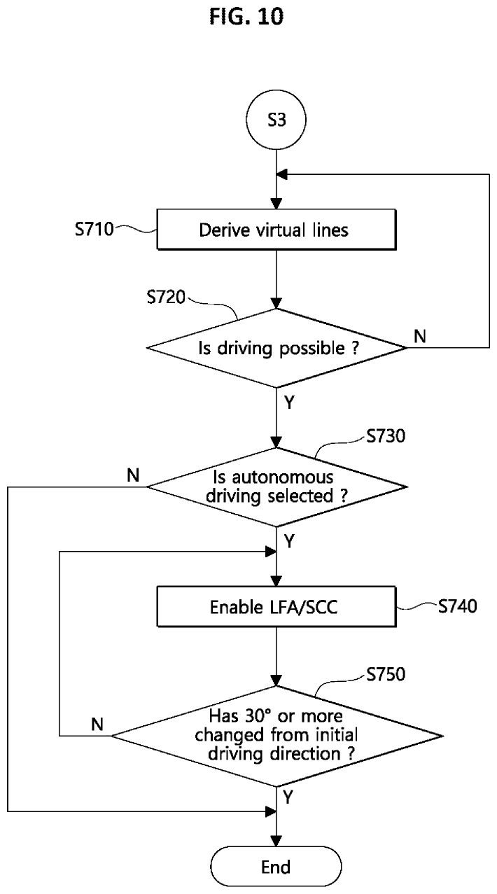

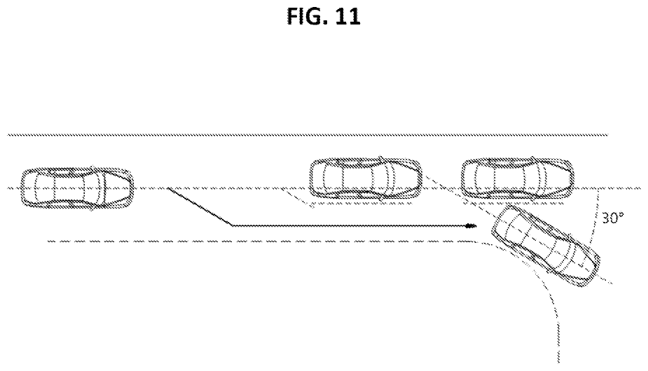

FIG. 10 is a flowchart illustrating a process of controlling an autonomous vehicle when a right turn signal is operated during driving on a narrow road in the method for controlling an autonomous vehicle according to the present disclosure and FIG. 11 is an exemplary view illustrating an embodiment of narrow road driving according to the case of FIG. 10. FIG. 10 shows a case in which the driver operates a right turn signal while avoiding a preceding vehicle at an intersection.

It is determined whether driving is possible by deriving virtual lines from the right side of the preceding vehicle and a curb. A new virtual line is derived by adding the width of the host vehicle and a safety margin to the right virtual line. The center of the existing right virtual line and the newly derived left virtual line becomes a virtual center line (S710).

If the width of a narrow road is greater than the width of the host vehicle, it may be determined that driving is possible (S720).

When it is determined that driving is possible, the controller 30 inquires of the driver whether to perform autonomous driving or driving by the driver through the interface. The driver may view the screen on which the virtual lines are displayed through the AVN system, determine the possibility of driving by the driver, and select driving by the driver or autonomous driving (S730).

If the driver selects autonomous driving, the function of the autonomous driving function unit 40 is executed. When autonomous driving is executed, the host vehicle travels along the newly acquired virtual center line closely to the right side according to the functions of LFA and SCC (S740).

When the current driving direction has changed from the initial driving direction by a preset angle or more (e.g., 30° or more), the vehicle is stopped. This is for the purpose of preventing a collision with a vehicle that is traveling straight through the intersection (S750).

The present disclosure can also be embodied as computer readable code or software stored on a computer readable recording medium such as a non-transitory computer readable recording medium. In one example, the memory 60 of the controller 30 may be implemented as a non-transitory computer readable recording medium to store the computer readable code. Examples of the computer readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, etc. The controller 30 may be implemented as a computer, a processor, or a microprocessor or may include a processor or a microprocessor. When the computer, the processor, or the microprocessor of the controller 30 reads and executes the computer readable code stored in the computer readable recording medium, the controller may be configured to perform the above-described operations/method. Similarly, the signal processing unit 30 may be implemented as a processor or a microprocessor. When the processor or the microprocessor of the signal processing unit 30 reads and executes corresponding computer readable code stored in the computer readable recording medium, the signal processing unit 30 may be configured to perform the corresponding operations/method.

As described above, the apparatus and method for controlling an autonomous vehicle according to the present disclosure can prevent the occurrence of a contact accident by controlling the autonomous driving function to be performed on a drivable narrow road to provide driving convenience to a novice driver who is inexperienced in driving and can improve reliability by reconfirming whether driving is possible by reflecting the driver's intention in determination of risk of various sensors.

Although the preferred embodiments of the present disclosure have been described above, it will be apparent to those skilled in the art that various modifications and variations can be made in the present disclosure without departing from the spirit or scope of the disclosure.

What is claimed is:

1. An apparatus for controlling an autonomous vehicle, comprising:
a sensor configured to acquire information data of obstacles and vehicles in front of and on a side of a host vehicle;
a signal processor configured to output data with respect to positions and media of the obstacles and a determination signal representing presence or absence of a vehicle on a driving path by using the information data acquired by the sensor;
a controller configured to determine whether driving is possible by analyzing the information data acquired by the sensor, to interface with a driver, and to output a control signal corresponding to a selection signal of the driver;
an interface configured to display an image processed by the signal processor and to interface with the controller; and
an autonomous driving function unit configured to perform autonomous driving according to the control signal provided from the controller.

2. The apparatus according to claim 1, wherein the sensor includes:
a non-image sensor configured to perform a sensing operation for extracting information on positions and media of the obstacles present in front of and on the side of the host vehicle; and
an image sensor configured to extract information on a front view image and a rear view image of the host vehicle.

3. The apparatus according to claim 2, wherein the non-image sensor includes at least one of a light detection and ranging (lidar) sensor, a radio detection and ranging (radar) sensor, an infrared sensor, and an ultrasonic sensor, and
wherein the image sensor includes a plurality of cameras.

4. The apparatus according to claim 2, wherein the signal processor receives information on reflected waves from an object in front of the host vehicle from the non-image sensor and acquires information on the medium of the object on the basis of a dielectric constant of the object.

5. The apparatus according to claim 1, wherein the signal processor determines that an object having a license plate in front of the host vehicle is a vehicle.

6. The apparatus according to claim 1, wherein the controller includes a storage storing a program for determining narrow roads on the basis of data acquired by the sensor, information on specifications of the host vehicle, and programs necessary for the operation of the autonomous driving function unit.

7. The apparatus according to claim 6, wherein the controller receives, from the driver, a signal for selecting autonomous driving or driving by the driver through the interface upon determining that driving is possible from a result of analysis based on the information data acquired by the sensor and the information on the specifications of the host vehicle.

8. The apparatus according to claim 6, wherein the controller receives a selection signal for an ignorable obstacle from the driver through the interface and re-determines whether driving is possible by reflecting the selection signal in the re-determination upon determining that driving is impossible from a result of analysis based on the information data acquired by the sensor and the information on the specifications of the host vehicle.

9. The apparatus according to claim 1, wherein the controller differentiates a condition that a vehicle is present in an opposite lane, a condition that no vehicle is present in the opposite lane, and a condition that a right turn signal is enabled from one another, derives virtual lines, and determines whether driving is possible.

10. The apparatus according to claim 1, wherein the controller outputs a control signal for enabling the autonomous driving function unit only when a signal for selecting autonomous driving is received from the driver on condition that driving is possible.

11. The apparatus according to claim 10, wherein the controller terminates the control signal for enabling the autonomous driving function unit when a vehicle in an opposite lane is captured by a rear camera on condition that a vehicle is present in the opposite lane.

12. The apparatus according to claim 10, wherein the controller controls the host vehicle to stop when a current driving direction has been changed from an initial driving direction by 30° or more on condition that a right turn signal is enabled.

13. The apparatus according to claim 1, wherein the autonomous driving function unit maintains a speed of the host vehicle at 20 km/h or lower.

14. A method for controlling an autonomous vehicle, comprising:
acquiring, by a sensor provided in a host vehicle, information data of obstacles and vehicles in front of and on a side of the host vehicle;
matching, by a signal processor provided in the host vehicle, information on the obstacles with an image acquired from a camera;
determining, by a controller provided in the host vehicle, whether driving is possible on the basis of image information and information on specifications of the host vehicle;
performing, by the controller, an operation of interfacing with a driver according to whether driving is possible; and
outputting, by the controller, a control signal for executing a function of an autonomous driving function unit when an autonomous driving selection signal is received from the driver.

15. The method according to claim 14, wherein the controller outputs the control signal for enabling the autonomous driving function unit only when the autonomous driving selection signal is received from the driver on condition that driving is possible.

16. The method according to claim 15, wherein the autonomous driving function unit performs autonomous driving differently according to a condition that a vehicle is present in an opposite lane, a condition that no vehicle is present in the opposite lane, and a condition that a right turn signal is enabled.

17. The method according to claim 15, wherein the controller terminates the control signal for enabling the autonomous driving function unit when a vehicle in an opposite lane is captured by a rear camera on condition that a vehicle is present in the opposite lane.

18. The method according to claim 15, wherein the controller controls the host vehicle to stop when a current driving direction has been changed from an initial driving direction by 30° or more on condition that a right turn signal is enabled.

19. The method according to claim 15, wherein the autonomous driving function unit maintains a speed of the host vehicle at 20 km/h or lower.

20. The method according to claim 14, wherein, upon determining that driving is impossible, the controller receives a selection signal for an ignorable obstacle from the driver and re-determines whether driving is possible by reflecting the selection signal in the re-determination.
